(19) United States
(12) Patent Application Publication
(10) Pub. No.: US 2007/0154666 A1
(43) Pub. Date: Jul. 5, 2007

(54) Powder injection molding of glass and glass-ceramics

(76) Inventors: Everett William Coonan, Painted Post, NY (US); John Joseph Costello III, Painted Post, NY (US); Sean Matthew Garner, Elmira, NY (US); Beth Costello Monahan, Painted Post, NY (US); Mark Alejandro Quesada, Horseheads, NY (US)

Correspondence Address: CORNING INCORPORATED, SP-TI-3-1, CORNING, NY, 14831, US

(21) Appl. No.: 11/394,692

(22) Filed: Mar. 31, 2006

Related U.S. Application Data
(60) Provisional application No. 60/755,637, filed on Dec. 31, 2005.

(51) Int. Cl. B28B 11/00; C04B 33/36; B28B 3/00

(52) U.S. Cl. 428/34.4; 264/645; 264/629

(57) ABSTRACT

A method for producing glass or glass ceramic articles by powder injection molding of glass powder includes mixing together, in a continuous mixing process, ingredients to form a mixture comprising a glass powder and a binder, where the ingredients include a glass powder in a relative amount sufficient to equal at least 50% by volume of the resulting mixture and a binder comprising a thermoplastic polymer, desirably a thermoplastic elastomer, and a wax; forming the mixture into a formed structure; and de-binding and sintering the formed structure. The method desirably involves mixing via a high intensity mixing process, desirably by mixing in a twin-screw extruder. The forming process may include pelletizing the mixture and injection molding the pelletized mixture to form the formed structure. The ingredients of the mixture desirably comprise a glass powder in a relative amount sufficient to equal at least 70% by volume of the resulting mixture. The glass powder desirably includes at least some glass particles having irregular shapes.

This application claims priority to U.S. provisional application No. 60/755,637 filed Dec. 31, 2005.

### BACKGROUND OF THE INVENTION

1. Field of the Invention

The present invention relates generally to the manufacture of glass and glass ceramic articles from glass powder by powder injection molding and particularly to an improved, more efficient process for production of glass and glass ceramic articles by powder injection molding and to articles produced thereby.

2. Technical Background

Glass and glass ceramic materials have beneficial properties for many applications. Outstanding properties such as chemical and physical durability, biological inertness, high temperature stability, and transparency of many glass-based materials have led to wide-ranging applications of such materials in chemical and biological laboratory and production processes. Glass materials have been used or suggested for use in biological well plates, “labs on a chip,” microreactors, and in other fluidics and microfluidics applications, for example. Glass and glass ceramic articles have also found broad use in many other industrial applications and in various consumer products.

In these and many other applications, it can often be desirable for articles formed of glass or glass-ceramic materials to have complex forms or shapes. Yet producing complex shapes in such materials can be difficult, partly because the very durability and inertness that make such materials desirable also make them difficult to etch, machine, or otherwise form by subtractive forming processes. For these reasons it can be desirable to be able to mold these materials into complex shapes.

A technique potentially useful for molding glass and glass-ceramics into complex shapes is powder injection molding. In powder injection molding, a powder is mixed with a polymer binder and the mixture is then injection molded. After de-molding, the resulting article is de-binded and sintered. High powder loading (high fraction of powder and low fraction of binder) is desirable to avoid excessive porosity, warping, and excessive shrinkage of the finished part. While powder injection molding has been applied extensively to metal forming and to some degree in ceramic forming processes, little attention has been paid to powder injection molding of glass-based materials. This may be because glass powder particles are typically quite irregular, while the generally understood ideal particle shape for powder injection molding is spherical with a slight aspect ratio, so as to maximize the flowing and packing abilities of the powder and binder mixture.

U.S. Pat. No. 5,602,197, “Reversible Polymer Gel Binders for Powder Forming” ('197 patent) (assigned to the assignee of the present application), discloses binder compositions and a method or process for powder injection molding using various powder types, including metal powders, ceramic powders, and a glass powder. The process as therein disclosed achieves high powder loading (50-75% by volume), but a more efficient process, more adaptable to a manufacturing or production environment, yet still capable of good performance including high powder loading, is desirable.

### SUMMARY OF THE INVENTION

In one aspect of the present invention, a method for producing glass or glass ceramic articles by powder injection molding of glass powder is provided. The method includes mixing together, in a continuous mixing process, ingredients to form a mixture comprising a glass powder and a binder, where the ingredients include a glass powder in a relative amount sufficient to equal at least 50% by volume of the resulting mixture and a binder comprising a thermoplastic polymer and a wax; forming the mixture into a formed structure; and de-binding and sintering the formed structure. The method desirably involves mixing via a high intensity mixing process, desirably by mixing in a twin-screw extruder. The forming process may include pelletizing the mixture and injection molding the pelletized mixture to form the formed structure. The ingredients of the mixture desirably comprise a glass powder in a relative amount sufficient to equal at least 70% by volume of the resulting mixture, and as high as 75%. The glass powder desirably includes at least some, and may consist principally of glass particles having irregular shapes.

According to one alternative embodiment of the method of the present invention, the method may further include, after de-molding and before de-binding, the step of stacking the formed structure with another structure and the sintering the two structures thereby adhering them together. The other structure may optionally be a structure formed by the same process as the original formed structure. By this process, complex enclosed geometries may be formed.

As a further alternative embodiment, the step of de-binding and sintering may further include pre-sintering the formed structure to produce a pre-sintered formed structure, stacking the pre-sintered formed structure with another structure, and sintering the stacked structures so as to adhere them together. This variation may offer an advantage where relatively long unsupported spans are intended to enclose large areas within the final structure.

The thermoplastic polymer is desirably a thermoplastic elastomer, such as tri-block styrene-ethylene/butylene-styrene copolymers like those sold as Kraton® G1650 and G1652 or combinations thereof. The wax is desirably one or more of hexadecanol and octadecanol.

The method of the present invention provides for high-throughput manufacture of structured glass articles, including articles with fine structure and enclosed spaces or other complex shapes. The resulting articles are shown to have good shape retention and surface properties.

Additional features and advantages of various embodiments of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a flow diagram of one embodiment of a process of the present invention;

FIG. 2 is a flow diagram of another embodiment of a process according to the present invention;

FIG. 3 is a flow diagram of still another embodiment of a process according to the present invention;

FIG. 4 is a cross-sectional view of an embodiment of a device made by an embodiment of a process according to the present invention;

FIG. 5 is the cross-sectional view of FIG. 4 after a final sintering step;

FIG. 6 is a digital image of a structure produced according to one process of the present invention;

FIG. 7 is a close-up digital image of the structure of FIG. 6;

FIG. 8 is a digital image of a structure produced according to another process of the present invention;

FIG. 9 is a digital image of a structure produced according to another process of the present invention.

FIGS. 10 and 11 are digital images of a fractured cross-section of a green (not de-binded) structure produced according to an embodiment of a process of the present invention.

FIGS. 12 and 13 are digital images of a fractured cross-section of a de-binded structure similar to the not de-binded structure of FIGS. 10 and 11.

FIG. 14 is a digital image illustrating the good shape and form retention obtained using an embodiment of the present invention.

### DETAILED DESCRIPTION OF THE PREFERRED EMBODIMENTS

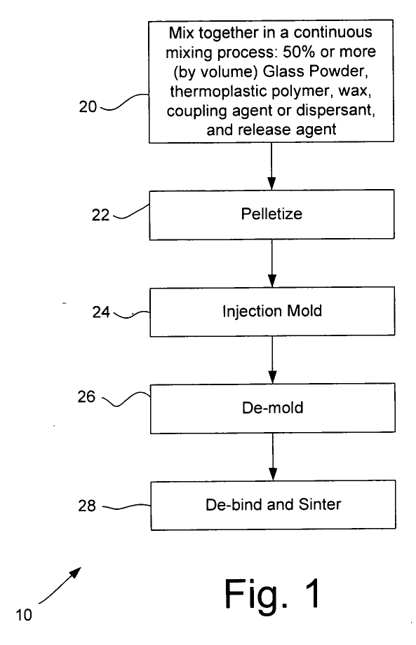

Reference will now be made in detail to the present preferred embodiment(s) of the invention, examples of which are illustrated in the accompanying drawings. Whenever possible, the same reference numerals will be used throughout the drawings to refer to the same or like parts. One embodiment of a method of the present invention is shown in FIG. 1, and is designated generally throughout by the reference numeral 10.

The method 10 illustrated in FIG. 1 includes the step 20 of mixing together, in a continuous mixing process, ingredients to form a mixture of glass powder and binder. The ingredients for step 20 include a glass powder material in a relative amount sufficient to equal at least 50% by volume of the resulting mixture, a binder material comprising a thermoplastic polymer and a wax, and may include a coupling agent and a dispersant or release agent. After mixing, the resulting feedstock is formed, desirably by being pelletized in step 22, then injection molded in step 24 to form a desired structure. Next, the resulting formed structure is de-molded in step 26 and de-binded and sintered in step 28.

Returning to step 20, the glass powder material may be of any desired type, including those that are crystallizing, phase separating, as well as amorphous-remaining upon sintering, or combinations of these. Powder particle size and size distribution may be determined in part by the sizes of the structures to be formed, as the inventive process has shown good performance over a significant range of particle sizes, with powders having 90% of particles less than 10 um to powders having 90% of particles less than 60 um, and even larger sizes.

The thermoplastic polymer is desirably a thermoplastic elastomer, most preferably a tri-block styrene-ethylene/butylene-styrene copolymer such as Kraton® G1650 or G1652 or mixtures thereof, available from Kraton Polymers, Houston, Tex. USA. The wax is desirably one or more of hexadecanol and octadecanol. The coupling agent is desirably an organotitanate such as neoalkoxy titanate or TRI (Dioctyl Phosphato) titanate, and may be diluted 3:1 in mineral oil and added in ratio 0.8 wt % to the powder material. The release agent is desirably a polyethylene wax. The wax, polymer, and release agent ingredients are desirably provided to the mixing device in a ratio of about to 60 wt. % wax, 30 wt. % Kraton®, and 10 wt. % release agent.

The mixing device used for step 20 is desirably a twin-screw extruder with screws designed for enhanced mixing. Mixing the glass powder and binder mixture described above within a twin-screw extruder provides a single-step, continuous mixing process easily adaptable to various types of mass-production demands. Powder loadings of above 50% by volume, and as high as 70 to 75% by volume produce homogeneous, well-behaved feedstock.

In contrast, according to the earlier '197 patent:
High powder loadings are achieved [by combining the sinterable powder] with a powder dispersant and a solvent for the dispersant to provide a powder slurry. In a separate container and separate mixing step, the thermoplastic polymer selected for incorporation in the binder is combined with a selected low-melting wax component at a temperature above the melting temperature of the wax, in order to provide a wax/polymer mixture comprising a uniform solution or dispersion of the polymer in the molten wax.
The powder slurry is next combined with the wax/polymer mixture and the combination is mixed together at a temperature above the melting temperature of the wax. Mixing is continued for a time at least sufficient to provide a homogeneous dispersion of the powder in the binder mixture, and will be sufficient to evaporate as much as possible the solvent component from the slurry. [T]hrough the incorporation of the powder component as a slurry rather than as a dry mill addition, higher loadings of the powder in the binder can be achieved.

Contrary to the method of the '197 patent quoted above, the method according to the present invention mixes the glass powder material with the other components of the mixture in a single continuous step 20, desirably performed in a twin screw extruder having a screw designed specifically for enhanced mixing. Surprisingly, in view of the above-quoted teaching of the '197 patent, high powder loading of 50% by volume and greater-up to 70 to 75% by volume—is achieved by the present invention, while good molding performance is maintained.

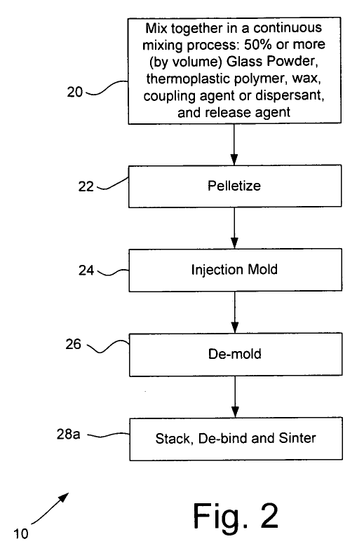

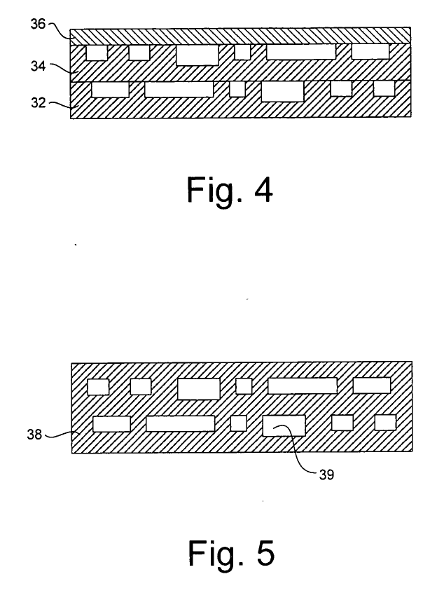

FIG. 2 shows another embodiment of the process or method of the present invention, according to which de-molded structures are first stacked, as shown in step 28a, then de-binded and sintered. This embodiment of the current invention may be used to produce enclosed structures such as enclosed microfluidic structures, as illustrated in FIGS. 4 and 5.

FIG. 4 shows three separate structures 32, 34, and 36. All three are desirably produced by the injection molding process steps of the present invention, up through step 26 of FIG. 2. Then all three are aligned and stacked together as shown in FIG. 4, in accordance with step 28a. After stacking, all three of the structures 32, 34, and 36 may then be de-binded and sintered at once, resulting in the three structures 32, 34, and 36 fusing to become a single structure 38 as shown in FIG. 5, thus providing gas- and liquid-tight sealing of interior spaces 39. The method of FIG. 2 thus provides for efficient and easy formation of complex interior structures within a glass or glass-ceramic article, and is accordingly useful in the formation of microfluidic devices such as microreactors and micro heat exchangers and the like.

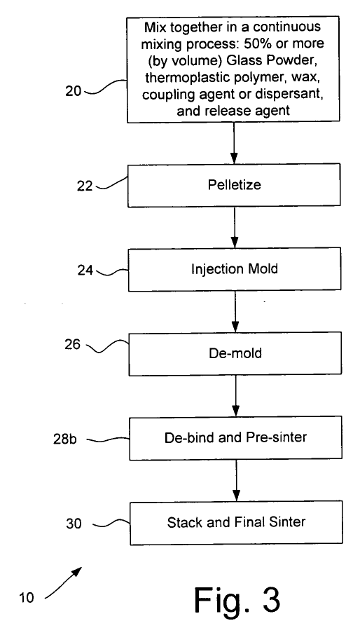

Another embodiment of the process of the current invention is shown in FIG. 3. The process of FIG. 3 is optimized for the production of articles like the one shown in FIGS. 4 and 5, but requiring even larger-span internal enclosures. For such articles, the possibility of sagging during de-binding and sintering exists. Accordingly in FIG. 3, step 28b includes de-binding and pre-sintering the molded part(s), naturally with adequate structural support. After pre-sintering in step 28b, the individual parts are ready for stacking and final sintering in step 30. In this manner good sealing between stacked layers is obtained without any sagging even over large-span internal enclosures.

According to other variations, the de-binding and sintering may be performed all at once or separately and independently as may be needed or desired to provide the desired degree (or lack) of porosity in the final product. Partial sintering may even be used intentionally to create an open-pore structure to provide a filter or other high-surface area device.

### EXAMPLES

### Example 1

Feedstocks were prepared in accordance with the methods outlined above, with various glass powders including powders of Corning glasses codes 7740, 7913, 7761 (Corning, N.Y., USA). Powder particle sizes were varied from 90%<10 um to 90%<60 um. Part molding (by injection molding), stacking, de-binding and sintering was performed. The process of the present invention provided good performance regardless of glass type, particle size, and particle size distribution within these ranges. Successful results for both sintering and stacking then sintering were obtained with glass various compositions, including compositions that remain amorphous, compositions that phase separate, and compositions that crystallize during sintering, demonstrating the versatility and wide application of the process for forming articles of both glass and glass-ceramic materials.

The process described above in conjunction with FIGS. 1-3 was used to produce closed microfluidic structures of the type shown in part in FIGS. 4-5. The molded parts prepared as described above using code 7761 glass available from Corning Incorporated, Corning, N.Y. USA, were debinded in an electric furnace with forced air flow, placed flat side down on porous alumina setter boards from Zircar Refractory Composites of Florida, N.Y., USA, using the following Debind schedule: Ramp 1 hr to 200° C.; Hold 1 hour; Ramp 7 hours to 630° C.; Hold 1 hour; Cool to ambient at furnace's natural rate. Debinded parts were then sintered in an electric-fired vacuum furnace, flat side down on alumina setters boards, using the following sintering schedule: Hold 6 hours at 30° C.—vacuum on; Ramp 8 hours to 800° C.; Hold 1 hour; Hold 0.5 hours—vacuum off; Cool to ambient at furnace's natural rate. For assembly of the multiple layers, the sintered layers were stacked on an alumina setter board and topped with another alumina setter weighing about 200 g, then fused together in an electric furnace using the following schedule: Ramp 2.5 hours to 800° C.; Hold 0.5 hours; Cool to ambient at furnace's natural rate.

### Example 2

The process described above in conjunction with FIGS. 1-3 was further used to produce closed microfluidic structures of the type shown in part in FIGS. 4-7 using code 7913 glass available from Corning Incorporated, Corning, N.Y. USA. Molded parts were debinded and sintered in an electric furnace with using the following schedule: Ramp to 225° C. at 2° C./minute; Hold 1 hour; Ramp to 1105° C. at 2° C./minute; Hold 60 minutes; Cool to ambient at furnace's natural rate.

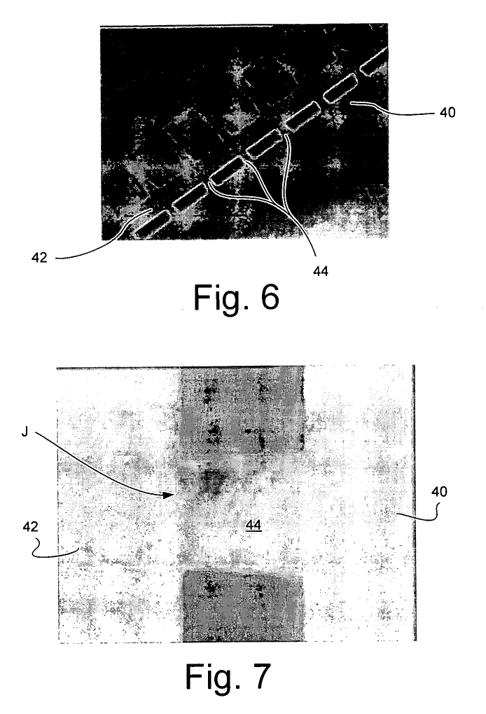

FIG. 6 shows a cross-sectional digital image of resulting sintered-together layers 40 and 42. The layers are adhered at wall structures 44 that stood originally on layer 40. FIG. 7 shows a close-up of one of the joints layer 40 and layer 42 are joined via wall structure 44, with the joint lying at the joint position indicate by the arrow J. As seen from the figure the area of the joint is well sealed and well joined. This illustrates the suitability of the inventive process for the formation of multi-part structures such as enclosed structures, including microfluidic structures such as microreactors or micro heat exchangers.

### Example 3

Fifty-seven single-layer molded parts were injection molded and ten parts sampled from the fifty-seven were sintered according to the process described above. Post-sintering dimensional variation was limited to 138.14±0.36 mm (0.26%) in length and 91.80±0.27 mm (0.29%) in width. For the sample of ten, sintering shrinkage was 9.1±0.3% for eleven selected local dimensions spread across the surface of the part.

### Example 4

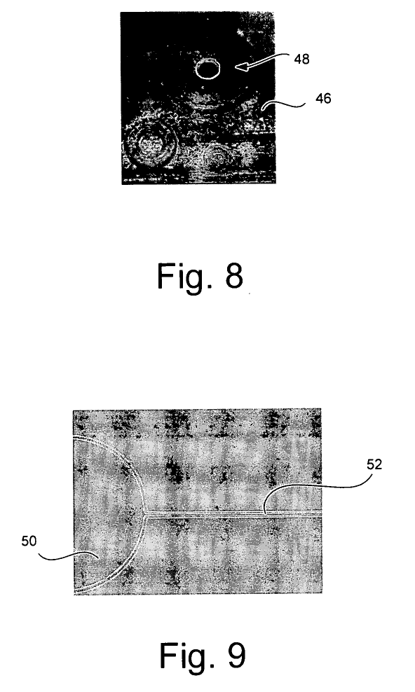

Layers with through-holes were successfully produced by the inventive process. Eliminating the need to drill through-holes in glass microfluidic devices can save substantial manufacturing expense. FIG. 8 is a digital image of a portion of a layer 46 having a through-hole 48.

### Example 5

Microchannels of post-sintering dimensions 200 um width, 10 um depth, and 56 mm length were produced in a layer having dimensions of about 2.5 cm×7.5 cm×1 mm, in accordance with the methods of the present invention. Corning code 7913 (Corning, N.Y., USA) glass powder was used. FIG. 9 is a digital image of a portion of the resulting structure, showing a portion of a fluidic reservoir 50 and microchannel 52. To evaluate the quality of the sintered microfluidic channels, a PDMS cover was placed on the fluidic substrates with appropriate holes punched for the inlets and outlets. After cleaning with IPA, proper sealing of the silicone to the glass substrate was obtained around the fluidic channel. A typical matrix gel used for bioseparations was then prepared and applied to the microfluidic inlet port. Due to capillary forces, this gel was observed to fill the entire fluidic channel all the way to the outlet port. This suggests that surface qualities (including surface zeta potential) in the sintered part approach that of bulk glass and thus demonstrates that functional glass microfluidic capillary channels can be fabricated from a powder material through an injection molding and sintering process according to the present invention.

### Example 6

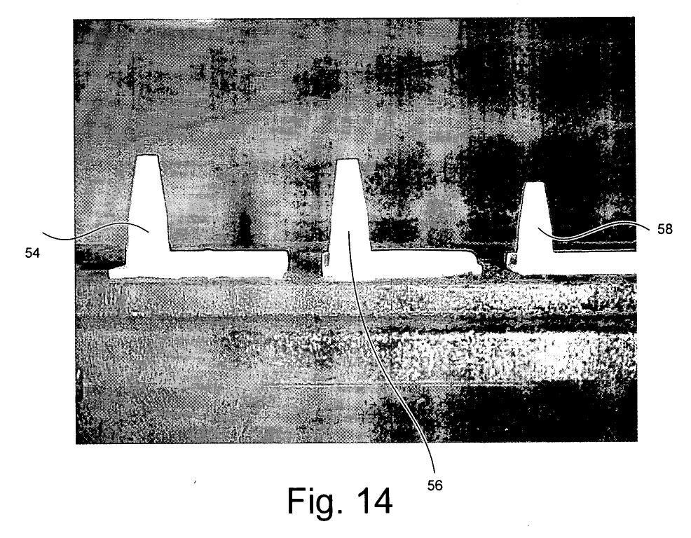

Tapered hollow cylindrical structures having dimensions on the order of about 15-20 mm height, 4-7 mm diameter and 1 mm wall thickness were injection molded and sintered according to an embodiment of the process of the present invention. Green, de-binded and fully sintered parts were compared. FIG. 14 is a digital image of three of the structures, showing a green structure 54, a de-binded structure 56, and a sintered structure 58 side-by-side for comparison. As may be seen from the image of FIG. 14, although some anisotropic shrinkage occurs from structure 54 to structure 58, the overall shape including the sharpness of the edges is well-preserved in structure from structure 54 to structure 58. As may be seen from the figure, in this embodiment of the invention, the de-binded structure 56 maintains about 94% of the size of the green structure 54, while the sintered structure 58 maintains about 84% of the width and 74% of the height of the green structure 56.

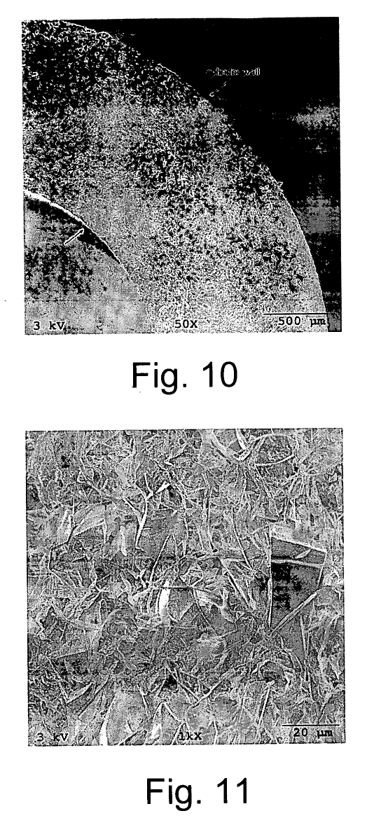

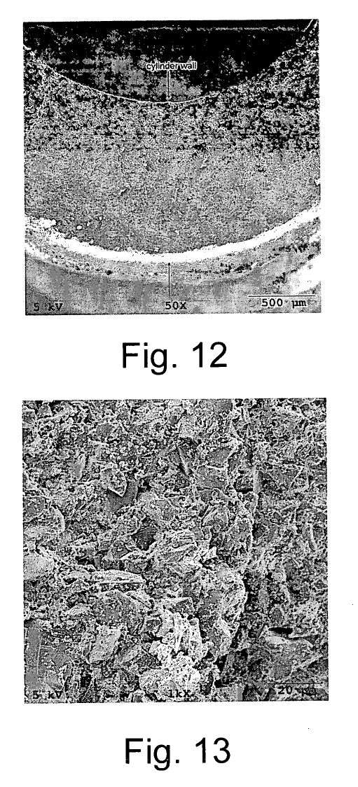

This excellent shape retention for relatively high-aspect-ratio structures is believed to be attributable at least in part to the properties of the preferred binder material discussed above. FIGS. 10 and 11 show different magnifications (50× and 1000×, respectively) of a fractured cross section of a green structure similar to structure 54 of FIG. 14. As may be seen from the figures, the binder material forms a web of filaments around and among irregular shaped particles of glass powder. FIGS. 12 and 13 show different magnifications (50× and 1000×, respectively) of a fractured cross section of a de-binded structure similar to structure 56 of FIG. 14. As may be seen from the figures, the web-like binder material is no longer present, but the irregular shaped particles of glass powder are now adhered closely to each other.

Some degree of irregularity of particles is believed desirable for preserving or green strength and desired final sintered shape. As a contrasting example, use in the context of the present invention of glass powder comprised essentially exclusively of round silica soot particles showed a tendency for the resulting formed article to disintegrate on debinding. Thus it is believed desirable to maintain some minimum portion of irregular particles in the glass powder.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method for producing glass or glass ceramic articles by powder injection molding of glass powder, the method comprising:
mixing together, in a continuous mixing process, ingredients to form a mixture comprising a glass powder and a binder, the ingredients comprising:
a glass powder in a relative amount sufficient to equal at least 50% by volume of the resulting mixture, and
a binder comprising a thermoplastic polymer and a wax;
forming the mixture so as to form of the mixture a first formed structure; and
de-binding and sintering the first formed structure.

2. The method of claim 1 wherein the step of mixing together comprises mixing via a continuous high intensity mixing process.

3. The method of claim 2 wherein the high intensity mixing process comprises mixing in a twin-screw extruder, continuous mixer, or kneader.

4. The method of claim 1 wherein the step of forming comprises pelletizing the mixture and injection molding the pelletized mixture to form the first formed structure.

5. The method of claim 1 wherein said ingredients comprise a glass powder in a relative amount sufficient to equal at least 70% by volume of the resulting mixture.

6. The method of claim 1 wherein said ingredients comprise a glass powder in a relative amount sufficient to equal 75% by volume of the resulting mixture.

7. The method of claim 1 wherein said ingredients comprise a glass powder that comprises glass particles having irregular shapes.

8. The method of claim 1 wherein said ingredients comprise a glass powder that consists principally of glass particles having irregular shapes.

9. The method of claim 1 wherein the method further comprises, after de-molding and before de-binding, the step of stacking the first formed structure with a second structure and wherein the sintering adheres together the first formed structure and the second structure.

10. The method of claim 9 wherein the second structure is a second formed structure.

11. The method of claim 1 wherein the step of de-binding and sintering further comprises
de-binding the first formed structure,
pre-sintering the first formed structure to produce a first pre-sintered formed structure,
stacking the first pre-sintered formed structure with a second structure, and
sintering the stacked first and second structures so as to adhere together the first and second structures.

12. The method of claim 11 wherein the step of stacking the first pre-sintered formed structure with a second structure comprises stacking the first pre-sintered formed structure with a second pre-sintered formed structure.

13. The method of claim 1 wherein said thermoplastic polymer comprises a thermoplastic elastomer.

14. The method of claim 13 wherein the thermoplastic elastomer comprises tri-block styrene-ethylene/butylene-styrene copolymers.

15. The method of claim 14 wherein the tri-block styrene-ethylene/butylene-styrene copolymers comprise one of Kraton® G1650 and G1652 and combinations thereof.

16. The method of claim 1 wherein the wax comprises a fatty alcohol.

17. The method of claim 16 wherein the fatty alcohol one or more of hexadecanol and octadecanol.

18. The method of claim 1 wherein the step of mixing together comprises mixing together, in a continuous mixing process, ingredients to form a mixture comprising a glass powder and a binder, the ingredients comprising:
a glass powder in a relative amount sufficient to equal at least 50% by volume of the resulting mixture,
a binder comprising a thermoplastic polymer and a wax, and
a release agent.

19. The method of claim 18 wherein the release agent comprises oxidized polyethylene wax.

20. The method of claim 1 wherein the step of mixing together comprises mixing together, in a continuous mixing process, ingredients to form a mixture comprising a glass powder and a binder, the ingredients comprising:
a glass powder in a relative amount sufficient to equal at least 50% by volume of the resulting mixture,
a binder comprising a thermoplastic polymer and a wax, and
a dispersant or coupling agent.

21. The method of claim 20 wherein the coupling agent comprises an organotitanate.

22. A glass or glass-ceramic article produced according to the method of claim 1.

23. A multi-layer fluidic or microfluidic device produced according to the method of claim 9.

24. A multi-layer fluidic or microfluidic device produced according to the method of claim 11.

25. A device including capillary structures produced according to the method of claim 1.

26. A method for producing glass or glass ceramic articles by powder injection molding of glass powder, the method comprising:
mixing together, in a continuous mixing process in a twin screw extruder, ingredients to form a mixture comprising a glass powder and a binder, the ingredients comprising:
a glass powder in a relative amount sufficient to equal at least 50% by volume of the resulting mixture,
a binder comprising a thermoplastic elastomer and a wax,
a release agent, and
a coupling agent or dispersant;
pelletizing the mixture;
injection molding the pelletized mixture to form a formed structure; and
de-binding and sintering the formed structure.

27. A method for producing glass or glass ceramic articles by powder injection molding of glass powder, the method comprising:
mixing together, in a continuous mixing process, ingredients to form a mixture comprising a glass powder and a binder, the ingredients comprising:
a glass powder in a relative amount sufficient to equal at least 50% by volume of the resulting mixture,
a binder comprising a thermoplastic elastomer and a wax,
a release agent, and
a coupling agent or dispersant;
forming the mixture into a first formed structure by injection molding; and
de-binding and sintering the first formed structure.
